(19) United States
(12) Patent Application Publication
(10) Pub. No.: US 2026/0336232 A1
(43) Pub. Date: Oct. 29, 2026

(54) MULTI-MATERIAL FIBER TOWS

(71) Applicant: UT-Battelle, LLC, Oak Ridge, TN (US)

(72) Inventors: Steven Guzorek, Knoxville, TN (US); James R. Tobin, Greenville, SC (US); Vlastimil Kunc, Knoxville, TN (US); Joshua D. Crabtree, Kingston, TN (US); Kim W. Sitzlar, Kingston, TN (US); Daniel R. Coughlin, Knoxville, TN (US)

(21) Appl. No.: 19/662,235

(22) Filed: Apr. 29, 2026

Related U.S. Application Data
(60) Provisional application No. 63/796,424, filed on Apr. 29, 2025.

(51) Int. Cl. B29C 70/20; B29C 70/52; B29K 307/04; B29K 309/08; B65H 69/06

(52) U.S. Cl. CPC B29C 70/20; B29C 70/521; B65H 69/061; B29K 2307/04; B29K 2309/08; B29K 2995/0077

(57) ABSTRACT

A multi-material fiber tow is provided. The multi-material fiber tow includes a first fiber tow comprising fibers of a first material having a first modulus; a second fiber tow comprising fibers of a second material having a second modulus different from the first modulus; and a transition region joining the first fiber tow and the second fiber tow. The fibers of the first fiber tow and the fibers of the second fiber tow are spliced within the transition region. A method of forming a multi-material fiber tow is also provided. The method includes providing a first fiber tow comprising fibers of a first material having a first modulus; providing a second fiber tow comprising fibers of a second material having a second modulus different from the first modulus; and splicing the fibers of the first fiber tow and the fibers of the second fiber tow together.

### CROSS-REFERENCE TO RELATED APPLICATIONS

This application claims the benefit of U.S. Provisional Application 63/796,424, filed Apr. 29, 2025, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to multi-material fiber tows and methods of forming multi-material fiber tows.

### BACKGROUND OF THE INVENTION

Composite manufacturing processes such as pultrusion, filament winding, continuous fiber fabric formation, automated fiber placement (AFP), and continuous fiber additive manufacturing enable the placement of continuous fiber reinforcements at relatively low resin fractions to produce composite articles for a wide range of applications, from advanced aerospace structures to vehicle components.

In such processes, design flexibility is typically achieved by controlling the orientation, placement, and stacking of a single fiber type within the structure. As a result, the primary design variables are limited to fiber direction and layer configuration, while the material composition of the reinforcement remains largely uniform along the length of the structure.

In many applications, higher-performance fibers, such as carbon fiber or high-modulus carbon fiber, are not required throughout the entire length of a component. Nevertheless, manufacturing constraints often result in such fibers being used continuously through regions where lower-cost or lower-modulus fibers would be sufficient. This can result in inefficient material utilization, increased cost, increased embodied energy, and unnecessary demand on supply chains for higher-value materials.

Conventional approaches for introducing transitions between dissimilar composite materials generally rely on scarf joints, bonded joints, lap joints, or mechanical connectors. Although such joints may permit load transfer between different composite sections, they introduce a number of disadvantages. For example, scarf joints may require relatively long transition regions in order to adequately transfer load and reduce stress concentrations. In some instances, the required transition length may be impractical, may exceed the available length of one of the materials being joined, or may reduce the economic benefit otherwise obtained by selectively using lower-cost reinforcement.

In addition, conventional approaches for joining dissimilar composite materials are typically performed after formation of the composite components, such as by joining separately formed composite members using scarf joints, bonded interfaces, or mechanical connectors. As a result, such approaches are not readily integrated into continuous composite manufacturing processes. The introduction of post-manufacture joints increases cost and manufacturing complexity and introduces discontinuities in reinforcement that may reduce structural efficiency.

Hybrid composite architectures have also been proposed in which different fiber materials are arranged in serial or parallel configurations within a composite structure. For example, different fiber materials may be positioned in different regions along a length of a structure to tailor stiffness or other properties, or may be arranged side-by-side within a cross-section to combine attributes of the constituent materials. Although such architectures may provide certain performance benefits, they do not necessarily provide a continuous tow-level transition between dissimilar fiber tows capable of transferring load across a spliced transition region. In addition, such approaches may remain constrained by manufacturing complexity, fixed cross-sectional arrangements, discontinuities between material regions, or limited compatibility with continuous composite manufacturing processes.

Accordingly, there remains a continued need for improved material transitions within composite structures, particularly approaches that enable load transfer between dissimilar materials while maintaining compatibility with continuous composite manufacturing processes.

### SUMMARY OF THE INVENTION

A multi-material fiber tow and methods of forming and using the same are provided. The multi-material fiber tow generally includes a first fiber tow comprising fibers of a first material having a first modulus and a second fiber tow comprising fibers of a second material having a second modulus different from the first modulus. A transition region joins the first fiber tow and the second fiber tow, wherein fibers of the first fiber tow and fibers of the second fiber tow are spliced within the transition region to form a load transfer region between the first fiber tow and the second fiber tow. In this manner, a continuous fiber tow can be formed that enables formation of a joint between dissimilar materials without the need for conventional composite-level joints, while maintaining compatibility with downstream composite manufacturing processes.

A method of forming a multi-material fiber tow is also provided. The method generally includes providing a first fiber tow comprising fibers of a first material having a first modulus, providing a second fiber tow comprising fibers of a second material having a second modulus different from the first modulus, and splicing the fibers of the first fiber tow and the fibers of the second fiber tow together to form a load transfer region between the first fiber tow and the second fiber tow.

### BRIEF DESCRIPTION OF THE DRAWINGS

FIG. 1 illustrates a schematic of one embodiment of a process for forming a multi-material fiber tow.

FIG. 2 illustrates a schematic of one embodiment of a process for forming a composite from a multi-material fiber tow.

FIG. 3 is a graph illustrating flexural strength of composite samples having varying carbon fiber tow content.

FIG. 4 is a graph illustrating flexural modulus for various single-material and multi-material fiber tows.

### DETAILED DESCRIPTION OF THE CURRENT EMBODIMENTS

A multi-material fiber tow and methods of forming the same are provided. As described herein, the disclosed systems and methods enable implementation of material transitions within composite structures at the fiber tow level, thereby reducing reliance on conventional composite-level joints, connectors, and bonded interfaces. The disclosed multi-material fiber tows and related methods enable formation of a joint between fibers of differing materials that facilitates load transfer while maintaining compatibility with various composite manufacturing processes.

More particularly, the disclosed multi-material fiber tow includes a first fiber tow, a second fiber tow, and a transition region joining the first fiber tow and the second fiber tow. Fibers of the first fiber tow and fibers of the second fiber tow are spliced within the transition region to form a load transfer region between the first fiber tow and the second fiber tow. The details of these components and methods are described in further detail below.

As used herein, “fiber tow” means a structure comprising a plurality of fibers extending generally along a longitudinal direction of the fiber tow. The fibers within each fiber tow may be arranged in a bundle or collection of filaments that are processed together as a unit during composite manufacturing operations.

The first fiber tow comprises fibers of a first material having a first modulus, and the second fiber tow comprises fibers of a second material having a second modulus different from the first modulus. The first and second materials are not particularly limited and may be selected based on desired structural and mechanical properties of the resulting composite.

Suitable materials for the first and second fiber tows may include, by non-limiting example, carbon fiber, glass fiber, basalt fiber, aramid fiber, polymer fibers, ceramic fibers, or combinations thereof. In certain embodiments, the first material comprises a high-modulus fiber and the second material comprises a lower-modulus fiber. In particular embodiments, the first material comprises carbon fiber and the second material comprises glass fiber. In other embodiments, the first and second materials may comprise materials having different moduli. Fiber tows may be selected or combined to provide substantially matched or predetermined fiber volume fractions across the transition region.

In some embodiments, the first fiber tow and the second fiber tow may comprise the same material. In such embodiments, the first fiber tow and the second fiber tow have different moduli. For example, the first fiber tow may comprise a higher-modulus fiber and the second fiber tow may comprise a lower-modulus fiber of the same material type. By way of non-limiting example, the first fiber tow may comprise carbon fibers having a high modulus and the second fiber tow may comprise carbon fibers having a low modulus. In this manner, the first fiber tow and the second fiber tow may be spliced within the transition region to form a dissimilar modulus tow.

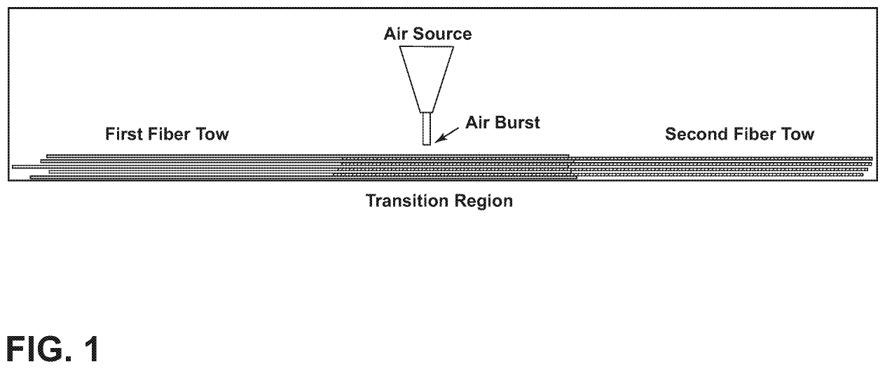

As shown in FIG. 1, the multi-material fiber tow includes a transition region joining the first fiber tow and the second fiber tow. The fibers of the first fiber tow and the fibers of the second fiber tow are spliced within the transition region to form a load transfer region between the first fiber tow and the second fiber tow.

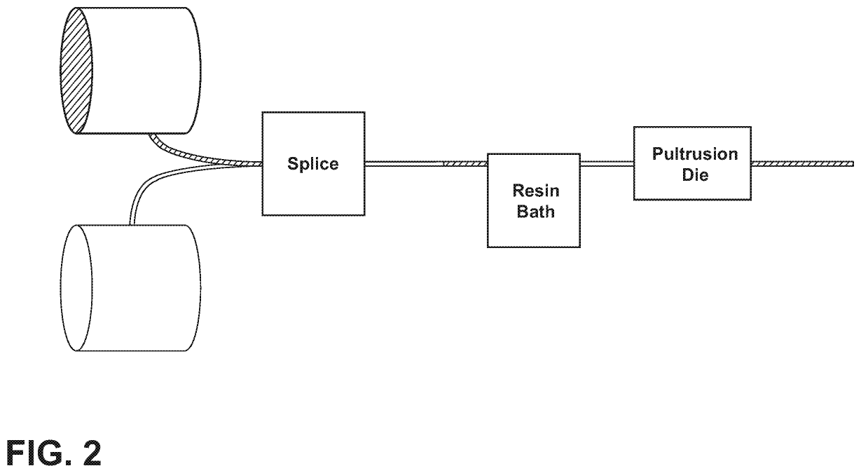

As shown in FIG. 2, the transition region may be configured such that the multi-material fiber tow can be processed as a continuous reinforcement through one or more downstream composite manufacturing processes. In this manner, the transition region enables material transitions within a continuous fiber tow without requiring formation of a composite-level joint between separately formed components. The transition region may have a defined axial length, which may be selected based on desired load transfer characteristics. The length of the transition region may be uniform or variable and may be optimized based on material properties, processing conditions, or structural requirements.

The fibers within the transition region may be joined using any suitable splicing or fiber-joining technique. In certain embodiments, fibers of the first fiber tow and fibers of the second fiber tow are entangled, intermingled, commingled, interlaced, wrapped and commingled, or otherwise combined to form the transition region. Suitable techniques may include, by way of non-limiting example, air splicing, commingled splicing, wrapped splicing, wrapped-and-commingled splicing, mechanical interlacing, or combinations thereof. It will be appreciated that the particular splicing technique is not limiting, provided that the resulting transition region enables load transfer between the first fiber tow and the second fiber tow. Such techniques are collectively referred to herein as “splicing.”

In certain embodiments, splicing is performed by overlapping a portion of the first fiber tow with a portion of the second fiber tow and directing compressed air at the overlapping portions to intermingle fibers from the respective tows. In some embodiments, the splicing process is pneumatic. In some embodiments, the overlap length is selected to provide a desired degree of intermingling and load transfer within the transition region. In some embodiments, the transition region comprises both intermingled fibers and a stabilizing wrap. In certain such embodiments, the transition region is formed by a combined entanglement-and-wrapping process, which may be referred to herein as “wrapped-and-commingled splicing.”

In some embodiments, the multi-material fiber tow includes a plurality of transition regions along a length of the multi-material fiber tow. The plurality of transition regions may be spaced along the length of the multi-material fiber tow to define material segments along the fiber tow. In certain embodiments, the location and spacing of the transition regions are selected based on structural requirements of a composite component, such that different materials are provided in different regions of the resulting composite structure.

In certain embodiments, the transition region comprises a tapered fiber transition. The tapered fiber transition may include a gradual redistribution of fibers along a length of the transition region to reduce stress concentrations and provide a gradual change in material properties between the first fiber tow and the second fiber tow. In some embodiments, fibers of one or both fiber tows are tapered, thinned, rarefied, or otherwise redistributed prior to or during splicing to facilitate formation of the joint. In certain embodiments, the transition region may include a gradient distribution of fibers such that a relative proportion of fibers of the first material and the second material varies along the length of the transition region.

In certain embodiments, the multi-material fiber tow may be formed from more than two fiber tows. For example, a plurality of fiber tows may be provided, each comprising fibers of a selected material having a selected modulus, and fibers from the plurality of fiber tows may be selectively spliced to form one or more transition regions along the multi-material fiber tow. In such embodiments, each fiber tow of the plurality of fiber tows may be independently selected with respect to material, modulus, filament count, or other properties, such that the selection of which fiber tows are spliced may be controlled to provide a desired material distribution along the multi-material fiber tow and resulting composite structure. In further such embodiments, the multi-material fiber tow may include transitions between multiple different materials or between multiple fiber tows having different moduli of the same material. Transition regions in different fiber tows may be positioned at different lengths along the multi-material tow such that the transition regions are staggered along the length of the multi-material fiber tow.

A method for producing a multi-material fiber tow is also provided. As shown in FIG. 1, the method includes providing a first fiber tow comprising fibers of a first material having a first modulus, providing a second fiber tow comprising fibers of a second material having a second modulus different from the first modulus, and splicing fibers of the first fiber tow and fibers of the second fiber tow together to form a load transfer region between the first fiber tow and the second fiber tow. In certain embodiments, as shown in FIG. 2, the resulting multi-material fiber tow may be infused with a resin and processed to form a composite article.

In certain embodiments, a plurality of fiber tows of a first material are selectively replaced by a plurality of fiber tows of a second material through sequential splicing operations. Such sequential splicing operations may be referred to herein as “multisplicing.” In some embodiments, multisplicing is used to incrementally increase or decrease the amount of a selected material along the length of the multi-material fiber tow.

The splicing of the first fiber tow and the second fiber tow is not particularly limited. Any suitable splicing or fiber-joining technique may be used to join fibers of the first fiber tow and fibers of the second fiber tow to form the load transfer region. In certain embodiments, fibers of the first fiber tow and fibers of the second fiber tow are entangled, intermingled, commingled, interlaced, wrapped and commingled, or otherwise combined. Suitable techniques may include, by way of non-limiting example, air splicing, commingled splicing, wrapped splicing, wrapped-and-commingled splicing, mechanical interlacing, or combinations thereof. In certain embodiments, fibers may be tensioned, flattened, spread, or otherwise conditioned prior to splicing. Following splicing, excess fibers may be trimmed or redistributed to define the transition region. In certain embodiments, splicing comprises wrapped-and-commingled splicing in which fibers of the first and second fiber tows are intermingled and subsequently wrapped or bound to stabilize the transition region.

In some embodiments, the method further includes providing at least one additional fiber tow. The at least one additional fiber tow may comprise fibers of a selected material having a selected modulus. In such embodiments, fibers of the first fiber tow, the second fiber tow, and the at least one additional fiber tow may be selectively spliced to form the multi-material fiber tow. In certain embodiments, a first fiber tow may be spliced to two or more fiber tows of another material. This configuration may be used to balance fiber volume fraction, for example where the fiber count, filament count, or reinforcement contribution of one fiber tow differs from that of another fiber tow. Such arrangements may reduce cost, embodied energy, and overall material usage by enabling selective placement of higher-value or higher-performance fibers only in regions where such properties are required, while lower-cost or lower-modulus fibers are used in other regions.

In certain embodiments, the disclosed multi-material fiber tow is incorporated into a continuous or discrete article having spatially varying structural, functional, or material requirements. By way of non-limiting example, the multi-material fiber tow may be used in composite structures, elongated composite articles, reinforced profiles, tapes, tubes, rods, cables, wires, coated wires, jacketed wires, sheathed members, overmolded members, printed composite articles, woven articles, braided articles, or other fiber-containing products. In some embodiments, fibers having different mechanical, structural, thermal, electrical, or other properties are selectively positioned in regions where such properties are desired, while other fibers are positioned in other regions. Such arrangements may reduce cost, embodied energy, or material usage while maintaining desired performance characteristics.

As shown in FIG. 2, in certain embodiments, the method may further comprise performing one or more post-splicing processing steps on the multi-material fiber tow. Such processing steps are not particularly limited and may include known methods for forming a composite material from fiber tows. In certain embodiments, the multi-material fiber tow is infused with a resin to form a resin-infused fiber tow. In some embodiments, the resin-infused fiber tow may be processed to form a composite structure. Suitable processes may include, by way of non-limiting example, pultrusion, automated fiber placement (AFP), filament winding, weaving, knitting, braiding, continuous fiber printing, or other continuous composite manufacturing processes.

In embodiments comprising a post-splicing processing step, the multi-material fiber tow may be formed in advance and provided as a pre-spliced tow having predetermined material segments along its length, which may be wound onto a spool for subsequent use in the composite manufacturing process. In other embodiments, splicing of fiber tows may be performed in-line with the composite manufacturing process, such that transition regions are formed during processing.

In such embodiments, the multi-material fiber tow may be provided in a dry state, partially impregnated state, or fully resin-impregnated state. In certain embodiments, the transition region is formed prior to resin infusion, while in other embodiments the transition region may be formed during or after partial impregnation.

As will be appreciated in view of the description herein, the scope of the multi-material fiber tows and manufacturing methods described herein is not particularly limited to the specific embodiments exemplified. In particular, the first material, the second material, the fiber tow construction, the splicing technique, the geometry of the transition region, and the downstream composite manufacturing process may be selected by one of ordinary skill in the art in view of the intended application, structural requirements, and processing configuration. The disclosed multi-material fiber tows may be incorporated into composite structures formed by pultrusion, filament winding, weaving, knitting, braiding, automated fiber placement, continuous fiber additive manufacturing, or other reinforcement-based composite processes.

### EXAMPLES

The present method is further described in connection with the following laboratory examples, which are intended to be non-limiting.

The specific materials, fiber types, component sources, equipment configurations, and processing conditions described in the foregoing examples are provided for illustrative purposes only. The invention is not limited to the particular material types, grades, suppliers, or commercial designations identified herein. Any suitable fibers, including but not limited to carbon fibers, glass fibers, basalt fibers, aramid fibers, polymer fibers, ceramic fibers, or combinations thereof, as well as any suitable splicing equipment, handling equipment, stabilization techniques, or downstream processing systems, may be used provided that they achieve substantially similar functionality. One of ordinary skill in the art will recognize that equivalent materials, fiber constructions, and processing conditions may be substituted without departing from the scope of the present invention.

Dry fiber preforms were prepared using a multisplicing approach prior to pultrusion, involving the combined use of a pneumatic fiber splicer and fiber-thread wrapping for splice stabilization. Splicing was performed using a pneumatic fiber splicer, with the fiber tows held under hand-applied tension to maintain alignment while promoting controlled intermingling of fibers from both strands. The splicing process utilized a compressed air pressure of 5.52 bar and produced a consistent splice overlap length of approximately 2 cm, after which excess fibers were trimmed. Following splicing, the joined fiber bundle was secured using a 30 Tex thread to stabilize the splice region, maintain tow integrity, and prevent fiber splaying during subsequent handling, impregnation, and feeding into a pultrusion line.

The resulting stabilized hybrid tow was then introduced into the pultrusion line for resin impregnation, consolidation, and curing. Pultrusion was conducted using Olin AIRSTONE 550E and 555H epoxy resin mixed at a 100:105 ratio, with a three-zone die temperature profile of 140 °C (Zone 1), 165 °C (Zone 2), and 190 °C (Zone 3) and a constant feed rate of 11.43 mm/s. The process was initiated using 22 tows of glass fiber (e.g., NEG XM2026) to establish steady-state processing conditions. To generate a longitudinally graded hybrid architecture, the carbon fiber tow count was incrementally increased along the length of the pultruded profile through sequential multisplicing events over a length of approximately 80 mm. The first transition was initiated approximately 1 m downstream of the first guide plate, where an operator manually cut one glass fiber tow and used the pneumatic splicer to incorporate one carbon fiber tow (e.g., Zoltek Panex 35) over a length of approximately 80 mm. This procedure was repeated to progressively replace glass fiber tows with carbon fiber tows.

Flexural strength of the hybrid pultruded composites produced using the above method was then measured. Flexural strength of the samples may be determined according to methods known in the art, such as ASTM C78/C78M or other comparable standardized test methods.

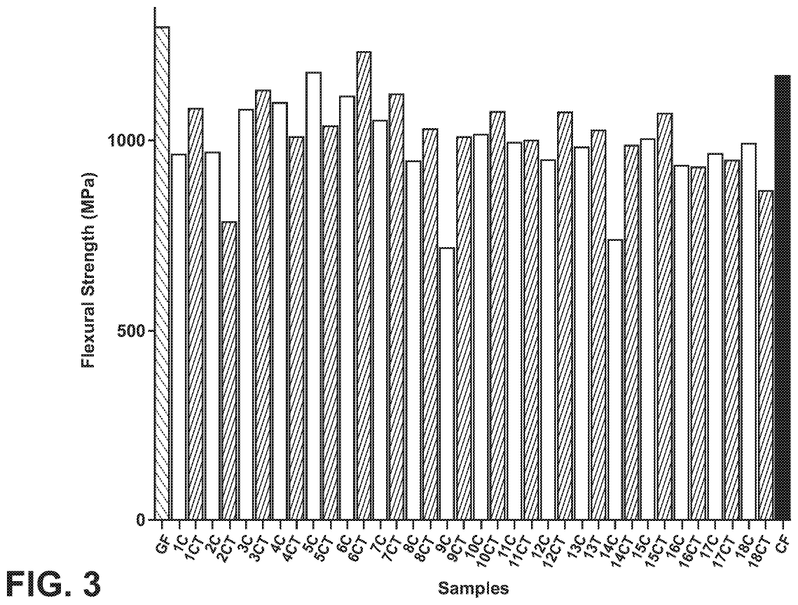

FIG. 3 presents a comparative performance assessment of the hybrid pultruded composites produced using a multisplicing approach that combines carbon and glass fiber tows along the length of the profile. In the sample nomenclature, 1C denotes a configuration with one carbon fiber tow, 2C denotes two carbon fiber tows, and so on, while the suffix CT (e.g., 1CT, 2CT) identifies samples tested at the carbon fiber-glass fiber transition region rather than within a uniform fiber segment. GF designates glass fiber and CF designates carbon fiber.

As shown in FIG. 3, a substantial fraction of the transition-point (CT) samples outperform their corresponding non-transition counterparts with equivalent nominal fiber content. 13 out of 18 cases (72.2%) exhibit higher flexural performance at the transition region. On average, the transition-point samples demonstrate an approximately 5% increase in flexural strength relative to their uniform counterparts, indicating that the carbon-glass transition regions are not intrinsically performance-limiting. The improved or comparable performance of the transition samples further indicates that the multisplicing strategy enables effective load transfer across the carbon fiber-glass fiber interface. While flexural strength generally decreases with increasing carbon fiber tow count, the observed behavior is not strictly monotonic. In certain configurations, localized increases in flexural strength are observed, indicating that mechanical performance may be influenced by local fiber distribution and hybrid reinforcement architecture in addition to nominal material composition.

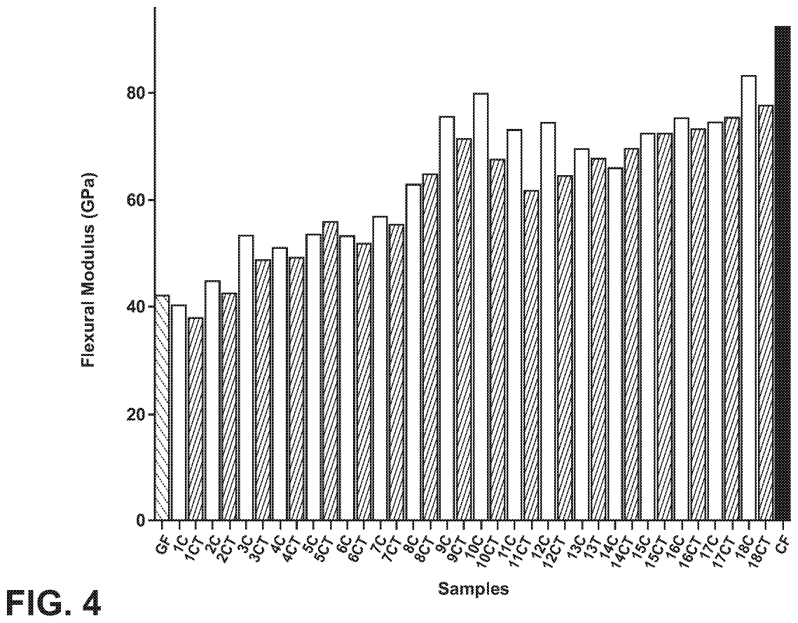

FIG. 4 presents a comparative assessment of flexural modulus for the hybrid pultruded composites produced using the multisplicing approach described herein. The sample nomenclature is consistent with that of FIG. 3, where 1C denotes a configuration with one carbon fiber tow, 2C denotes two carbon fiber tows, and so on, while the suffix CT (e.g., 1CT, 2CT) identifies samples tested at the carbon fiber-glass fiber transition region rather than within a uniform fiber segment. GF designates glass fiber and CF designates carbon fiber.

As shown in FIG. 4, flexural modulus generally increases with increasing carbon fiber tow content, progressing from values associated with glass fiber-dominated configurations toward those associated with carbon fiber-dominated configurations. In contrast to the flexural strength behavior described above, the transition-point (CT) samples less frequently exceed the modulus of their corresponding uniform configurations. A paired comparison indicates that approximately 4 out of 18 configurations (about 22%) exhibit higher modulus at the transition region relative to the corresponding uniform configuration. In the remaining configurations, the transition-point samples exhibit comparable or slightly reduced modulus, reflecting the effect of localized hybridization and stiffness averaging between carbon and glass fibers within the transition region. Notwithstanding this localized effect, the overall increase in modulus with increasing carbon fiber content is preserved across both uniform and transition configurations, progressing from approximately 42 GPa for the glass-fiber-only configuration toward approximately 92 GPa for the carbon-fiber-only configuration. In certain configurations, particularly at intermediate and higher carbon fiber tow counts, transition-point samples exhibit modulus values comparable to or slightly exceeding those of corresponding uniform configurations, suggesting that factors such as fiber intermingling, redistribution, and consolidation within the transition region may influence stiffness response. These results indicate that the multisplicing approach enables formation of a continuous multi-material fiber tow that incorporates dissimilar fibers while maintaining predictable stiffness scaling based on constituent material properties.

The results demonstrate that dissimilar modulus fiber transitions mitigate performance degradation that may otherwise be associated with changes in fiber composition. These results further demonstrate that the transition regions enable effective load transfer between dissimilar fiber materials.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A multi-material fiber tow, the tow comprising:
a first fiber tow comprising fibers of a first material having a first modulus;
a second fiber tow comprising fibers of a second material having a second modulus different from the first modulus; and
a transition region joining the first fiber tow and the second fiber tow, wherein the fibers of the first fiber tow and the fibers of the second fiber tow are spliced within the transition region to form a load transfer region between the first fiber tow and the second fiber tow.

2. The multi-material fiber tow of claim 1, wherein the first material comprises a high-modulus fiber and the second material comprises a lower-modulus fiber.

3. The multi-material fiber tow of claim 1, wherein the first material comprises carbon fiber and the second material comprises glass fiber.

4. The multi-material fiber tow of claim 1, wherein fibers of the first fiber tow and the second fiber tow are entangled within the transition region.

5. The multi-material fiber tow of claim 1, wherein the transition region is formed by one or more of air splicing, commingled splicing, wrapped splicing, and wrapped-and-commingled splicing.

6. The multi-material fiber tow of claim 1, wherein the transition region comprises a tapered fiber transition.

7. The multi-material fiber tow of claim 1, wherein the multi-material fiber tow includes a plurality of transition regions along a length of the multi-material fiber tow.

8. The multi-material fiber tow of claim 7, wherein the plurality of transition regions are spaced along a length of the multi-material fiber tow.

9. The multi-material fiber tow of claim 1, wherein the first fiber tow is spliced to two or more fiber tows of the second material to balance fiber volume fraction.

10. A method of forming a multi-material fiber tow, the method comprising:
providing a first fiber tow comprising fibers of a first material having a first modulus;
providing a second fiber tow comprising fibers of a second material having a second modulus different from the first modulus; and
splicing the fibers of the first fiber tow and the fibers of the second fiber tow together to form a load transfer region between the first fiber tow and the second fiber tow.

11. The method of claim 10, wherein splicing the fibers of the first fiber tow and the fibers of the second fiber tow together comprises one or more of air splicing, commingled splicing, wrapped splicing, and wrapped-and-commingled splicing.

12. The method of claim 10, wherein the first material comprises a high-modulus fiber and the second material comprises a lower-modulus fiber.

13. The method of claim 10, wherein the first material comprises carbon fiber and the second material comprises glass fiber.

14. The method of claim 10, wherein splicing the fibers of the first fiber tow and the fibers of the second fiber tow together forms an intermingled fiber region.

15. The method of claim 10, further comprising forming a plurality of load transfer regions along a length of the multi-material fiber tow.

16. The method of claim 15, wherein the plurality of load transfer regions are spaced along the multi-material fiber tow to provide predetermined material segments.

17. The method of claim 10, further comprising providing at least one additional fiber tow, and selectively splicing fibers of the first fiber tow, the second fiber tow, and the at least one additional fiber tow to form the multi-material fiber tow, wherein the at least one additional fiber tow comprises fibers of a selected material having a selected modulus.

18. The method of claim 17, further comprising infusing the multi-material fiber tow with a resin to form a resin-infused multi-material fiber tow.

19. The method of claim 18, further comprising processing the resin-infused multi-material fiber tow by one or more of pultrusion, filament winding, weaving, knitting, braiding, continuous fiber printing, and automated fiber placement (AFP) to form a composite structure.

20. The method of claim 10, wherein splicing the fibers further comprises splicing the first fiber tow to two or more fiber tows of the second material.
